(19) United States
(12) Patent Application Publication
(10) Pub. No.: US 2005/0149431 A1
(43) Pub. Date: Jul. 7, 2005

(54) Methods for converting renters into property owners

(76) Inventor: Sean M. Delaney, Las Vegas, NV (US)

Correspondence Address: WEISS & MOY PC, 4204 NORTH BROWN AVENUE, SCOTTSDALE, AZ, 85251, US

(21) Appl. No.: 10/750,730

(22) Filed: Jan. 5, 2004

(51) Int. Cl. G06F 17/60

(52) U.S. Cl. 705/38

(57) ABSTRACT

Methods for converting a renter into a property owner in cooperation with an investor comprise a third party finding the renter as well as the investor agreeing to purchase a property selected by the renter. During a phase one period of time the investor receives rent from the renter and obtains an increase in the property value until the beginning of a phase two period of time. Beginning phase two the renter obtains a new first mortgage to purchase the property at market value, the investor providing a sufficient second mortgage so that the renter requires no down payment to purchase the property. At the end of phase two, the renter obtains a further new first mortgage discharging the investor second mortgage and the investor gaining a portion of the new market value of the property. The methods repeat during phase two providing the investor with increased income potential.

### FIELD OF THE INVENTION

This invention relates generally to real estate business methods, and more specifically, to business methods for converting renters into property owners in cooperation with investors initiated by a third party.

### BACKGROUND OF THE INVENTION

In the past, new buyers of property have been somewhat limited in their ability to buy property, especially when the buyers have limited financial means or have credit problems. Various loan packages have helped buyers obtain properties, but not all potential buyers have been able to qualify for a loan.

One method that has been used with some success involves the buyer buying a property on the basis of renting the property with an option to buy the property from a seller for a mutually agreed price at a later pre-determined time. Usually, the buyer makes a nominal earnest deposit, and pays rent to the seller of the property at an agreed rent. A portion of the rent is credited to the renter/buyer towards the later purchase of the property. The seller of the property may misjudge the rate at which the property increases in value from the time of the initial rent-to-own purchase agreement to the later transfer of the property to the renter/buyer. In this situation the seller assumes a loss of potential appreciation in value of the property. If the property value decreases, the renter/buyer may not exercise the option to buy the property, leaving the seller to re-market the property, which may have been maintained poorly and therefore further devalued.

In the rent-to-own scenario discussed above, the renter/buyer usually has no opportunity to buy new property and is limited in selecting only those properties that are being offered as rent-to-own properties. It would be preferable for a renter/buyer to be able to select property in a similar manner as a regular buyer of property. At the same time a seller of a rent-to-own property would prefer to be insulated from the responsibilities of being a landlord and potential appreciation losses if the renter/buyer decided against exercising the option to buy the property.

For the foregoing reasons, there is a need to provide improved business methods for converting renters into property owners in cooperation with investors initiated by a third party. This disclosure outlines business methods that benefit both renter/buyers and investors who fund the purchase of property for a renter/buyer with the aid of a third party.

### SUMMARY OF THE INVENTION

Accordingly, it is an object of this invention to provide improved business methods for converting renters into property owners in cooperation with investors initiated by a third party.

It is a still further object of this invention to provide improved business methods for selecting properties for renters/buyers.

It is a still further object of this invention to provide improved business methods for financing properties for purchase by renter/buyers.

It is a still further object of this invention to provide improved business methods for investors to realize appreciable financial gains with minimal risks in a repetitive fashion.

### PREFERRED EMBODIMENTS OF THE INVENTION

In accordance with one embodiment of this invention, a method for converting a renter into a property owner comprises the steps of finding an investor wishing to invest in at least one property that can be rented; finding the renter wishing to rent the property; and obtaining the agreement of the investor to purchase the property selected by the renter.

In accordance with a second embodiment of this invention, a method for converting a renter into a property owner with the assistance of an investor comprises the steps of locating the investor wishing to invest in at least one property that can be rented using a third party; locating the renter wishing to rent the property using the third party; using the guidance of the third party by the renter to select the property; and obtaining the agreement of the investor by the third party for purchasing the property selected by the renter.

In accordance with a third embodiment of this invention, a method initiated by a third party for converting a renter into a property owner in co-operation with an investor comprises the steps of locating the investor wishing to invest in at least one property that can be rented using the third party; locating the renter wishing to rent the property using the third party; and obtaining the agreement of the investor to purchase the property selected by the renter using the third party.

The foregoing and other objects, features, and advantages of the invention will be apparent from the following, more detailed description of the preferred embodiments of the invention, as illustrated in the accompanying drawings.

### BRIEF DESCRIPTION OF THE DRAWINGS

FIG. 1A is a first portion of a flow diagram showing a method for converting renters into property owners in cooperation with investors initiated by a third party;

FIG. 1B is a second portion of the flow diagram of FIG. 1A showing the method for converting renters into property owners in cooperation with investors initiated by the third party; and

FIG. 2 is a timeline flow diagram for the method of FIGS. 1A and 1B for converting renters into property owners in cooperation with investors initiated by the third party.

### DESCRIPTION OF THE INVENTION

In this disclosure, certain abbreviations have been used in the figures, and the meaning of the abbreviations is as follows: MTG means mortgage, LTV means loan to value.

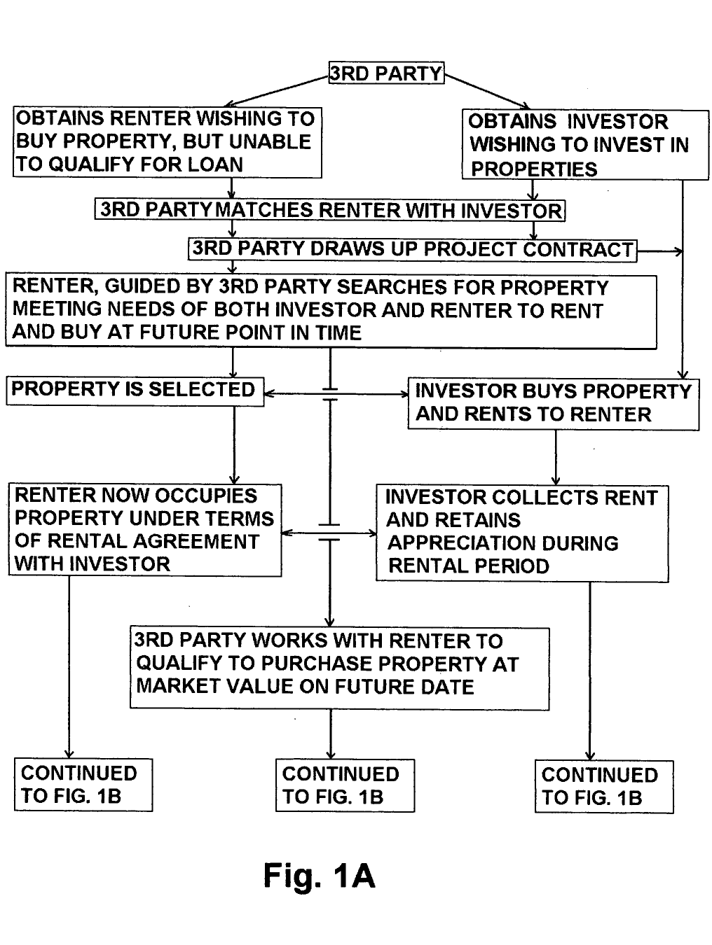

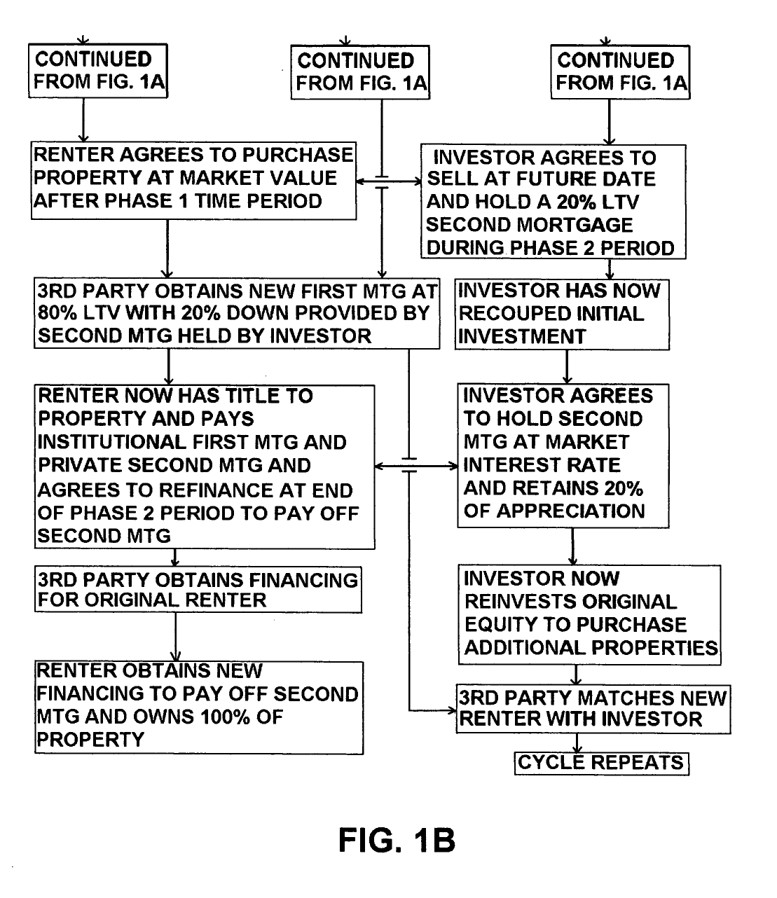

Referring to FIG. 1A, a first portion of a flow diagram shows a method for converting renters into property owners in cooperation with investors initiated by a third party. According to FIG. 1A, the third party obtains at least a renter who is unable to qualify for a loan but wishes to buy a property. The third party also obtains at least an investor wishing to invest in a plurality of properties. The third party matches the renter with the investor drawing up a project contract between the investor and the renter. The third party helps the renter search for a suitable property that meets the needs of both the investor and the renter, so that the renter may buy the property at a future pre-determined time at the market value of the pre-determined time. It is understood that the renter, under the guidance of the third party, is completely free to choose the desired property, whether it is new or in the secondary market, provided the property meets the investment needs of the investor. When the property is selected by the renter, the investor makes an initial investment by purchasing the selected property and enters a rental agreement with the renter. It is understood that the investor may obtain a mortgage on the selected property based on the investor's ability to qualify for a loan and the investor's desire to obtain the mortgage. Alternatively, it is understood the investor may self-finance the purchase of the property. During the rental period, the investor collects rent from the renter and retains any appreciation of the selected property. Meanwhile, the third party works with the renter to qualify the renter for a loan to purchase the property at a later time at a future market value.

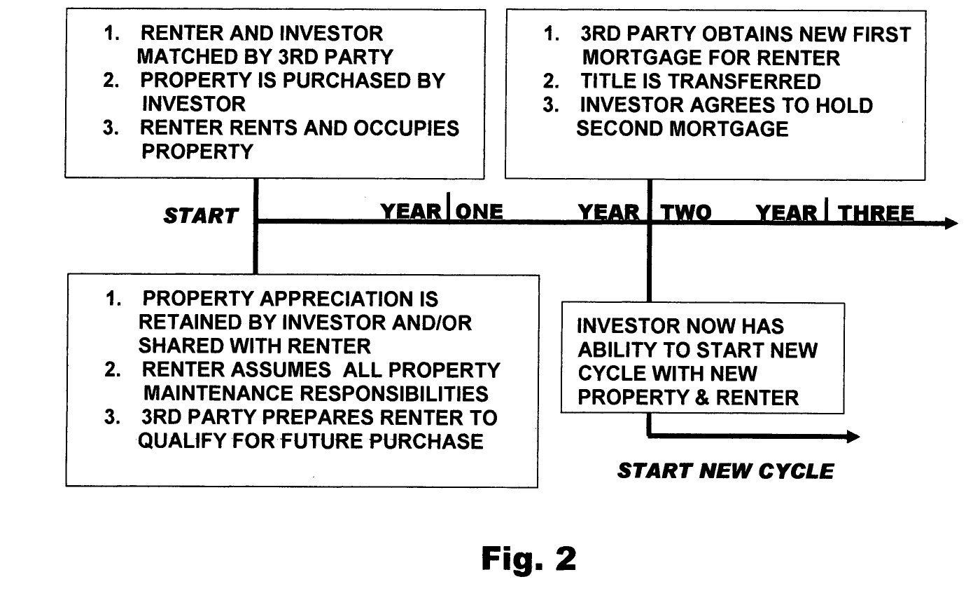

Referring to FIGS. 1B and 2, at the time of initiating the transaction between the renter and the investor, the renter agrees to purchase the property at the end of a phase one period of time at the market value at the end of a phase one period of time and the investor agrees to sell the property while providing a 20% loan to value second mortgage for a phase two period of time, thereby providing the renter with a deposit for obtaining a new first mortgage for the property. It is understood that the agreement between the investor and the renter may be structured in a variety of ways. For example, the period of time between initial purchase of the property and the sale of the property to the renter may be altered by mutual agreement between the renter and the investor. At the end of the phase one period of time, the third party obtains the new first mortgage at 80% of the loan to value of the market value of the property for the renter, with the remaining balance of the loan coming from the investor as described above. It is understood that the investor may choose to provide a loan to value second mortgage in excess of 20% for the phase two period of time. The investor has now recouped the investor's initial investment. In addition, the renter now has title to the property, while paying for an institutional first mortgage and the investor's second mortgage. For the phase two period of time after the sale of the property to the renter at the end of the phase one period of time, the investor holds the second mortgage at a prevailing market interest rate. The investor also retains 20% appreciation of the value of the property. It is understood that if the investor chooses to provide a loan to value second mortgage in excess of 20% for the phase two period of time, the investor retains a greater appreciation of the property based on the amount of the loan to value second mortgage. The investor may now reinvest the investor's original equity to purchase a further plurality of properties. The third party matches a new renter with the investor and the cycle repeats. Meanwhile, at the end of the phase one period of time and through the phase two period of time, the third party works with the investor to obtain new financing for the renter to pay off the investor's second mortgage, so that the renter now owns 100% of the property by the end of the phase two period of time.

Referring to FIG. 2, a timeline flow diagram for converting renters into property owners in cooperation with investors initiated by the third party is shown. Initially, the renter and the investor are matched by the third party. The property is purchased by the investor and the renter occupies the property while paying rent to the investor. From the time of initial purchase until a future date shown in FIG. 2 to be about two years of the project contract, the value of the property appreciation is retained by the investor. It is to be understood that the investor and the renter may agree to share the increase in the value of the property appreciation. During the above mentioned two year period of the project contract the renter assumes all property maintenance responsibilities. In addition the third party prepares the renter to qualify for the future purchase of the property during the about first two years of the project contract. As further shown in FIG. 2, at about the second year of the project contract the third party obtains a new first mortgage for the renter with the investor holding a second mortgage on the property. Title of the property is now transferred to the renter. The investor is now able to begin a new investment cycle where the third party matches a new renter to the investor. According to FIG. 2, the preferred length of the phase one period of time is at least about the first two years of the project contract, and the preferred length of the phase two period of time is at least about a second two years of the project contract, so that the total time period for the project contract is at least about four years. It is understood that the length of the phase one period of time may be extended to permit the renter to build up sufficient capital reserves to improve the renter's credit worthiness.

The advantages of the project contract from the investor's point-of-view are numerous. The maximum appreciation of the property is likely to occur in at least about the first four years of the project contract between the third party, the renter and the investor. The investor is a passive participant in the property selection since the third party works with the renter to search out properties with maximum investment potential for the investor. The investor is assured of maximum appreciation because of the pre-arranged sale of the property at the end of the project contract. The investor avoids the expense of time and effort needed to locate the optimum property and research the relevant market issues because the renter shops for the property under the supervision of the third party, thus eliminating the legwork for the investor. Therefore, the small investor is able to realize an equal or better profit margin compared to large corporate investors, without needing to deal with the prerequisite education, legwork, time and property management issues usually involved in property investments. Since the third party obtains the renter and the renter will become an owner of the property, the investor is relieved from the traditional obligations of landlord ownership, such as property maintenance, lowered occupancy rates that lower the return on investment and rent collection. In addition, the investor is provided with the opportunity to obtain lower interest rate short-term money to fund the property purchase and is able to collect rent from the renter knowing that there will be 100% occupancy of the property, thereby maximizing cash flow. The renter is motivated to continue proper upkeep and add improvements to the property as built into the project contract assuring unencumbered ownership for the renter after at least about four years.

The advantages of the project contract from the renter's point-of-view are also numerous. The renter requires no down payment for the property purchase and does not need to be qualified for the loan that is obtained for the renter after at least about two years of occupancy of the property. The selection of the neighborhood and construction of the property is left to the renter as guided by the project contract for maximum benefit to both investor and renter. The renter has a larger selection of properties that will be available compared to a normal rent-to own contract as discussed above. The renter may immediately make improvements to the property without having the constraints of temporary occupancy and landlord involvement. The renter also knows that the improvements made to the property will eventually result in an increase in the appreciation of the property value, for which the renter will be rewarded at a future period of time. As the project contract progresses in time, the renter's credit worthiness improves. In at least about the first two years of the project contract the investor realizes tax benefits, while in at least about the remaining two years of the project contract both the investor and the renter realize tax benefits.

While the invention has been particularly shown and described with reference to preferred embodiments thereof, it will be understood by those skilled in the art that the foregoing and other changes in form and details may be made therein without departing from the spirit and scope of the invention. For example, the term “property” may designate real estate of various types and other types of real property, which may be improved and preferably appreciates in value over a period of time. The phase one period of time and the phase two period of time may be altered to suit both the investor and the renter. The agreement between the investor and the renter may be altered by mutual agreement between the investor and the renter to optimize the needs of both the investor and the renter. Any third party, preferably a third party, that provides a service as described above, may act between the renter and the investor that provides a service as described above.

1. A method for converting a renter into a property owner comprising the steps of: finding an investor wishing to invest in at least one property that can be rented; finding said renter wishing to rent said property; and obtaining the agreement of said investor to purchase said property selected by said renter.

2. The method for converting a renter into a property owner according to claim 1 wherein a third party finds said investor and said third party finds said renter.

3. The method for converting a renter into a property owner according to claim 1 further comprising the steps of: receiving rent for said investor from said renter during a phase one period of time; obtaining a new first mortgage for said renter to purchase said property selected by said renter from said investor for a current market value at the beginning of a phase two period of time; providing a sufficient second mortgage by said investor so that said renter requires no down payment to purchase said property selected by said renter; and achieving an increase in the value of said property for said investor selected by said renter when said renter obtains said new first mortgage.

4. The method for converting a renter into a property owner according to claim 3 further comprising the steps of: obtaining a further new first mortgage for said renter thereby discharging said sufficient second mortgage provided by said investor; and gaining a portion of a new current market value of said property selected by said renter for said investor at the end of said phase two period of time.

5. The method for converting a renter into a property owner according to claim 4 further comprising the steps of: finding an other renter to purchase an other property selected by said other renter during said phase two period of time; receiving rent for said investor from said other renter during an other phase one period of time; obtaining an other new first mortgage for said other renter to purchase said other property selected by said other renter from said investor for an other current market value at the beginning of an other phase two period of time; providing an other sufficient second mortgage by said investor so that said other renter requires no down payment to purchase said other property selected by said other renter to provide said investor with increased income potential; and achieving an increase in the value of said other property selected by said other renter for said investor during said other phase one period of time.

6. The method for converting a renter into a property owner according to claim 5 further comprising the steps of: obtaining an other further new first mortgage for said other renter thereby discharging said an other sufficient second mortgage provided by said investor; and gaining a portion of an other new current market value of said other property selected by said other renter for said investor at the end of said other phase two period of time.

7. The method for converting a renter into a property owner according to claim 2 further comprising the steps of: selecting said property by said renter with the guidance of said third party, provided said property meets the investment needs of said investor; making an initial investment by said investor to purchase said property selected by said renter; and entering a rental agreement between said renter and said investor.

8. The method for converting a renter into a property owner according to claim 3 further comprising the step of: qualifying the renter during the phase one period of time for a loan to purchase said property selected by said renter at the beginning of said phase two period of time for said current market value.

9. The method for converting a renter into a property owner according to claim 3 wherein said phase one period of time is at least about two years and said phase two period of time is at least about two years and said phase one period of time may be extended so as to permit said renter to build up sufficient capital reserves to improve the credit worthiness of said renter.

10. The method for converting a renter into a property owner according to claim 3 wherein said sufficient second mortgage provided by said investor at the beginning of said phase two period of time is at least 20% of said current market value of said property selected by said renter.

11. The method for converting a renter into a property owner according to claim 10 wherein when said renter obtaining a further new first mortgage to discharge said at least 20% second mortgage provided by said investor, said investor gaining at least 20% of a new current market value of said property selected by said renter at the end of said phase two period of time.

12. A method for converting a renter into a property owner with the assistance of an investor comprising the steps of: locating said investor wishing to invest in at least one property that can be rented using a third party; locating said renter wishing to rent said property using said third party; using the guidance of said third party by said renter to select said property; and obtaining the agreement of said investor by said third party for purchasing said property selected by said renter.

13. The method for converting a renter into a property owner with the assistance of an investor according to claim 12 further comprising the steps of: receiving rent for said investor from said renter during at least about a first two year period of time; obtaining a new first mortgage for said renter to purchase said property selected by said renter from said investor for a market value at the end of about said first two year period of time; providing at least a 20% second mortgage by said investor so that said renter requires no down payment to purchase said property selected by said renter; and achieving an increase for said investor in the value of said property selected by said renter when said renter obtains said new first mortgage.

14. The method for converting a renter into a property owner with the assistance of an investor according to claim 13 further comprising the steps of: obtaining a further new first mortgage for said renter to discharge said 20% second mortgage provided by said investor; and gaining a portion of a new market value of said property selected by said renter for said investor at the end of about at least a second two year period of time.

15. The method for converting a renter into a property owner with the assistance of an investor according to claim 14 wherein said investor gaining at least 20% of said new current market value of said property selected by said renter at the end of about at least said second two year period of time.

16. The method for converting a renter into a property owner with the assistance of an investor according to claim 13 further comprising the steps of: finding an other renter to purchase an other property selected by said other renter in co-operation with said third party during about at least said second two year period of time; receiving rent for said investor from said other renter during a third about at least two year period of time; obtaining an other new first mortgage for said other renter to purchase said other property selected by said other renter for a market value at the beginning of a fourth about at least a two year period of time; providing an other at least 20% second mortgage by said investor so that said other renter requires no down payment to purchase said other property selected by said other renter to provide said investor with increased income potential; and achieving an increase in the value of said other property selected by said other renter by said investor during said third about at least two year period of time.

17. The method for converting a renter into a property owner with the assistance of an investor according to claim 16 further comprising the steps of: obtaining an other further new first mortgage for said other renter thereby discharging said 20% second mortgage provided by said investor; and gaining a portion of an other new market value of said other property selected by said other renter for said investor at the end of about at least said fourth two year period of time.

18. A method initiated by a third party for converting a renter into a property owner in co-operation with an investor comprising the steps of: locating said investor wishing to invest in at least one property that can be rented using said third party; locating said renter wishing to rent said property using said third party; and obtaining the agreement of said investor to purchase said property selected by said renter using said third party.

19. The method initiated by a third party for converting a renter into a property owner in co-operation with an investor according to claim 18 further comprising the steps of: receiving rent for said investor from said renter during a phase one period of time; obtaining a new first mortgage by said renter to purchase said property selected by said renter from said investor for a current market value at the beginning of a phase two period of time; providing a sufficient second mortgage by said investor so that said renter requires no down payment to purchase said property selected by said renter; achieving an increase in the value of said property selected by said renter for said investor when said renter obtains said new first mortgage; obtaining a further new first mortgage for said renter thereby discharging said sufficient second mortgage provided by said investor; and gaining a portion of a new current market value of said property selected by said renter for said investor at the end of said phase two period of time.

20. The method initiated by a third party for converting a renter into a property owner in co-operation with an investor according to claim 19 further comprising the steps of: finding an other renter to purchase an other property selected by said other renter using said third party during said phase two period of time; receiving rent for said investor from said other renter during an other phase one period of time; obtaining an other new first mortgage by said other renter to purchase said other property selected by said other renter for an other current market value at the beginning of an other phase two period of time; providing an other sufficient second mortgage by said investor so that said other renter requires no down payment to purchase said other property selected by said other renter to provide said investor with increased income potential; and achieving an increase in the value of said other property selected by said other renter for said investor during said other phase one period of time.

21. The method initiated by a third party for converting a renter into a property owner in co-operation with an investor according to claim 20 further comprising the steps of: obtaining an other further new first mortgage for said other renter thereby discharging said an other sufficient second mortgage provided by said investor; and gaining a portion of an other new current market value of said other property selected by said other renter for said investor at the end of said other phase two period of time.
